(19) United States
(12) Patent Application Publication
(10) Pub. No.: US 2012/0126500 A1
(43) Pub. Date: May 24, 2012

(54) STABILIZATION MECHANISM FOR LUGGAGE

(75) Inventors: Robin Rankin, Toronto (CA); James T. Sener, Glastonbury, CT (US); Christopher D. Hageman, South Glastonbury, CT (US); David L. Mathieu, Colchester, CT (US); Scott Smith, Hartford, CT (US)

(73) Assignee: TRAVELPRO INTERNATIONAL, INC., Boca Raton, FL (US)

(21) Appl. No.: 13/295,502

(22) Filed: Nov. 14, 2011

Related U.S. Application Data
(60) Provisional application No. 61/414,925, filed on Nov. 18, 2010.

(51) Int. Cl. B62B 1/04

(52) U.S. Cl. 280/47.2

(57) ABSTRACT

A stabilization mechanism for luggage is provided. The stabilization mechanism can be disposed on the bottom of a compartment of luggage and in spaced relation to wheels that are also disposed on the bottom of the compartment. The stabilization includes at least one foot that is retractable within the compartment, so that in the retracted position the volume of the luggage is substantially the same as the luggage compartment. When the at least one foot is deployed, the likelihood of tipping of the luggage is decreased, as the foot, in conjunction with the wheels, maintain the luggage in a substantially vertical position.

### CROSS-REFERENCE TO RELATED APPLICATION DATA

This present application claims priority from U.S. Provisional Patent Application No. 61/414,925, filed on Nov. 18, 2010, the contents of which are incorporated herein by reference.

### FIELD

The present specification relates generally to luggage and more specifically relates to a stabilization mechanism for luggage.

### BACKGROUND

Travel is a common human activity and luggage is an important feature of travel. When it comes to air travel, the demands on luggage can be particularly intense.

### SUMMARY

A stabilization mechanism for luggage is provided. The stabilization mechanism can be disposed on the bottom of a compartment of luggage and in spaced relation to wheels that are also disposed on the bottom of the compartment. The stabilization includes at least one foot that is retractable within the compartment, so that in the retracted position the volume of the luggage is substantially the same as the luggage compartment. When the at least one foot is deployed, the likelihood of tipping of the luggage is decreased, as the foot, in conjunction with the wheels, maintain the luggage in a substantially vertical position.

### BRIEF DESCRIPTION OF THE DRAWINGS

Reference will now be made, by way of example only, to the accompanying drawings in which:

FIG. 1 is a perspective view of luggage comprising a stabilization mechanism.

FIG. 2 shows a configuration of the handle of the luggage of FIG. 1 whereby the handle can retract within a chamber disposed on the compartment of the luggage.

FIG. 3 shows the luggage of FIG. 1, including the handle and stabilization mechanism, in a retracted position.

FIG. 4 is a sectional view of the luggage of FIG. 1 showing the stabilization mechanism.

FIG. 5 is a top view of the stabilization mechanism of FIG. 4.

FIG. 6 is a right-side view of the stabilization mechanism of FIG. 4.

FIG. 7 is a left-side view of the stabilization mechanism of FIG. 4.

FIG. 8 is a bottom view of the stabilization mechanism of FIG. 4.

FIG. 9 is a rear view of the stabilization mechanism of FIG. 4.

FIG. 10 is a front view of the stabilization mechanism of FIG. 4.

FIG. 11 is a bottom perspective view of the stabilization mechanism of FIG. 4 in the extended position.

FIG. 12 is a bottom perspective view of the stabilization mechanism of FIG. 4 in the retracted position.

FIG. 13 is a right-side sectional view of the stabilization mechanism of FIG. 4 through the lines XIII-XIII of FIG. 4.

FIG. 14 is a sectional perspective view of the stabilization mechanism of FIG. 4 through the lines XIV-XIV of FIG. 4.

FIG. 15 is a top sectional view of the stabilization mechanism of FIG. 4 through the lines XV-XV of FIG. 4.

FIG. 16 is a top view of the stabilization mechanism of FIG. 4 having an optional protective cover disposed thereon.

FIG. 17 is a perspective view of another stabilization mechanism.

FIG. 18 is a perspective view of another stabilization mechanism.

FIG. 19 is a perspective view of the stabilization mechanism of FIG. 18.

FIG. 20 is a perspective view of another stabilization mechanism.

### DETAILED DESCRIPTION OF THE EMBODIMENTS

As used herein, any usage of terms that suggest an absolute orientation (e.g. “top”, “bottom”, “front”, “back”, etc.) are for illustrative convenience and refer to the orientation shown in a particular figure. However, such terms are not to be construed in a limiting sense as it is contemplated that various components will, in practice, be utilized in orientations that are the same as, or different than those described or shown.

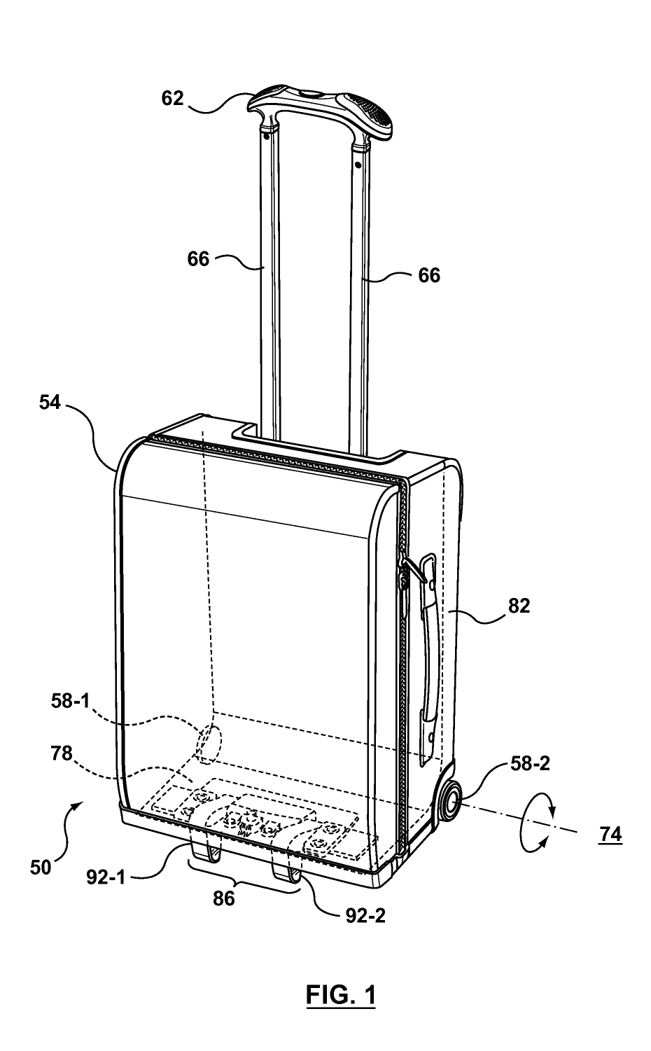

Referring now to FIG. 1, an article of luggage is indicated generally at 50. In a non-limiting example embodiment, luggage 50 comprises a compartment 54 for storing and transporting personal effects or other articles.

Compartment 54 which can be opened to receive or remove articles, and can be closed for storage or transportation. It is to be understood that the nature of compartment 54 is not particularly limited, and that variations on the configuration of the compartment 54 shown in the Figures are contemplated. For example, compartment 54 can be made of a hard material (e.g. plastic or metal) or a soft material (e.g. fabric). Compartment 54 can also have different configurations, including a split configuration comprising two equal size halves or non-equal size halves. Compartment 54 can be a backpack, a dufflebag, or a briefcase or other type of object for transport. Compartment 54 can also be configured to open from one or more different sides, and the means by which it is opened is not particularly limited. Likewise the configuration, orientation and type of hinging mechanism is not particularly limited. A variety of other types of compartments will now occur to those skilled in the art.

Luggage 50 also comprises a plurality of wheels 58-1, 58-2. (Collectively, wheels 58, and generically, wheel 58. This nomenclature is used elsewhere herein.) Wheels 58 are mounted to compartment 54, and can be used to roll luggage 50 along a substantially smooth surface. In a present embodiment, two wheels 58 are provided. As seen in FIG. 1 each wheel can rotate along a rotational axis 74 that is substantially parallel to a rolling surface so that luggage 50 can be rolled along the surface. In variations, not shown, wheels 58 may also be configured to spin along an axis that is perpendicular to axis 74, to thereby change the orientation of rotational axis 74. In the present embodiment, two wheels 58 are provided and mounted at opposite corners of the junction of a base 78 of compartment 54 and a first wall 82 of compartment 54. It should be understood that in other embodiments a fewer or greater number wheels may be provided.

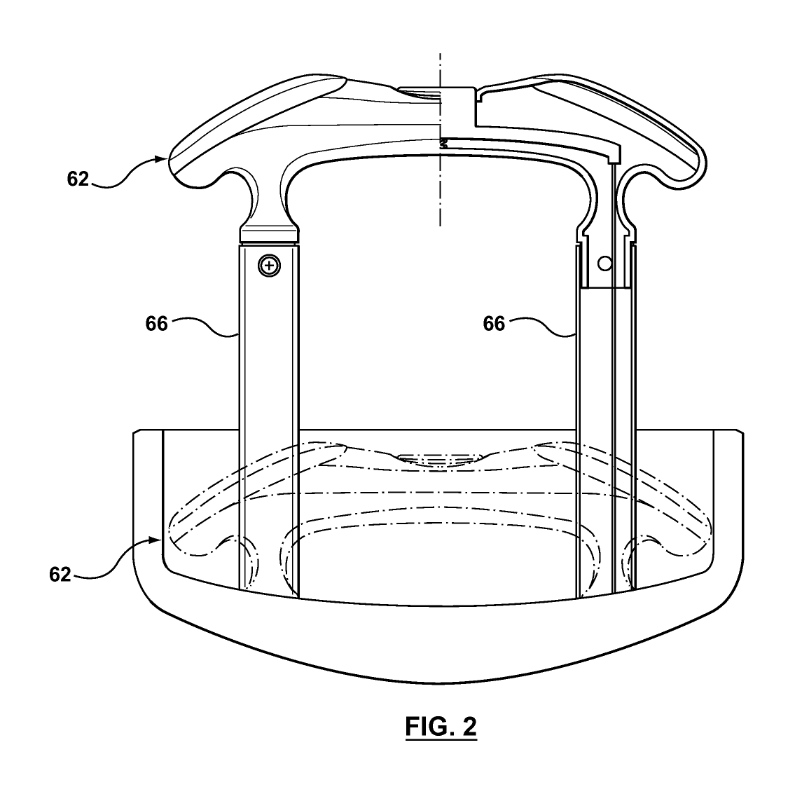

Referring still to FIG. 1, luggage 50 also comprises a handle 62 that connects to compartment 54 via a pair of retractable rods 66. In FIG. 1, rods 66 are in an extended position so that handle 62 is brought within an arm's reach while a person is standing substantially upright. Referring briefly to FIG. 2, rods 66 may be retracted so that handle 62 sits within a cavity provided within compartment 54. It should be understood that other configurations of handle 62 are contemplated, and that rods 66 can be implemented by a single rod. Other variations on rod 66 and handle 62 will become apparent to the skilled reader when the full teachings of this specification are fully appreciated.

Referring again to FIG. 1, luggage 50 also comprises a retractable stabilization mechanism 86, disposed substantially centrally within base 78 of compartment 54. In the present embodiment stabilization mechanism 86 is implemented with a first retractable foot 92-1 and a second retractable foot 92-2. In variations, a fewer or a greater number of feet may be provided. Feet 92 are shown in the extended position in FIG. 1 and are substantially perpendicular to the rolling surface, while base 78 is oriented substantially in parallel with the rolling surface. Stabilization mechanism 86 thus reduces the likelihood of luggage 50 tipping over. Such possibility of tipping may be increased due to the distribution of contents of compartment 54, changing the center of gravity of luggage 50 to the point where luggage 50 is prone to tipping.

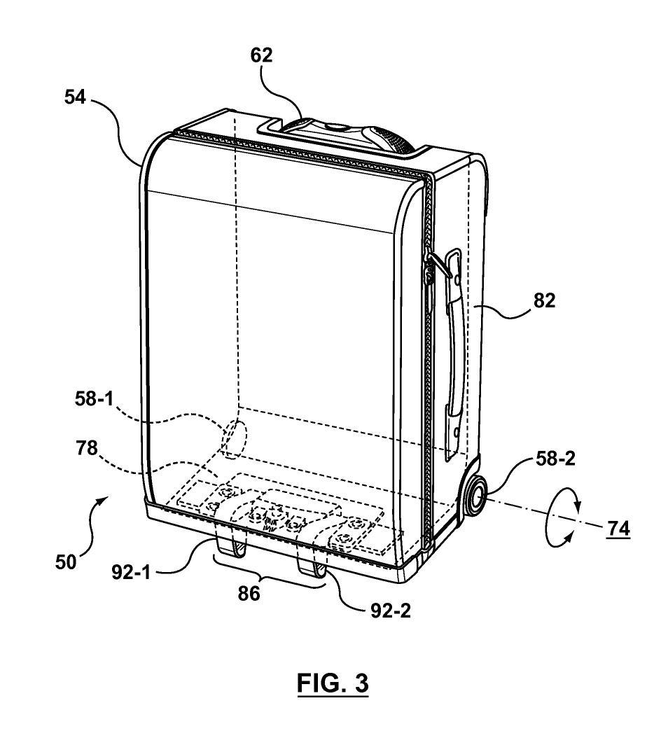

Still referring to FIG. 1, in use, handle 62 can be used to tilt luggage 50 so that base 78 and first wall 82 are angled in relation to the rolling surface, and then pulled (or pushed) to roll luggage 50 along the rolling surface. Luggage 50 can also be left standing in the position shown in FIG. 1. As seen in FIG. 3, luggage 50 also has a stowage position whereby handle 62 is retracted (as shown in FIG. 2) and stabilization mechanism 86 is also retracted. In the stowage position of FIG. 3, the volume occupied by luggage is reduced in relation to the extended position in FIG. 1, thereby reducing the volume needed to accommodate luggage 50 within a storage compartment, or an x-ray scanner, or in a luggage sorting machine, or the like. In general, the stowage position reduces the volume of luggage 50 to substantially the volume of compartment 54. As a more specific but non-limiting example, when compartment 54 is substantially cuboid, then the stowage position also renders luggage 50 as substantially cuboid. The stowage feature presents one of the advantages of the present specification, due to the fact that many airlines utilize hollow cuboids to measure carry-on baggage. Such hollow cuboids are intended to reflect the limitations of the carry-on baggage compartments in aircraft, and therefore any carry-on luggage are expected to fit within such a hollow cuboid to qualify for carry-on status. Similar restrictions may also be in found in other transit contexts (e.g. storage bins on buses, trains) and storage compartments (e.g. lockers). Thus, any protrusions from the compartment 54 are expected to also fit within the cuboid shape, thereby leading to a reduction in the possible volume for compartment 54 to accommodate such protrusions.

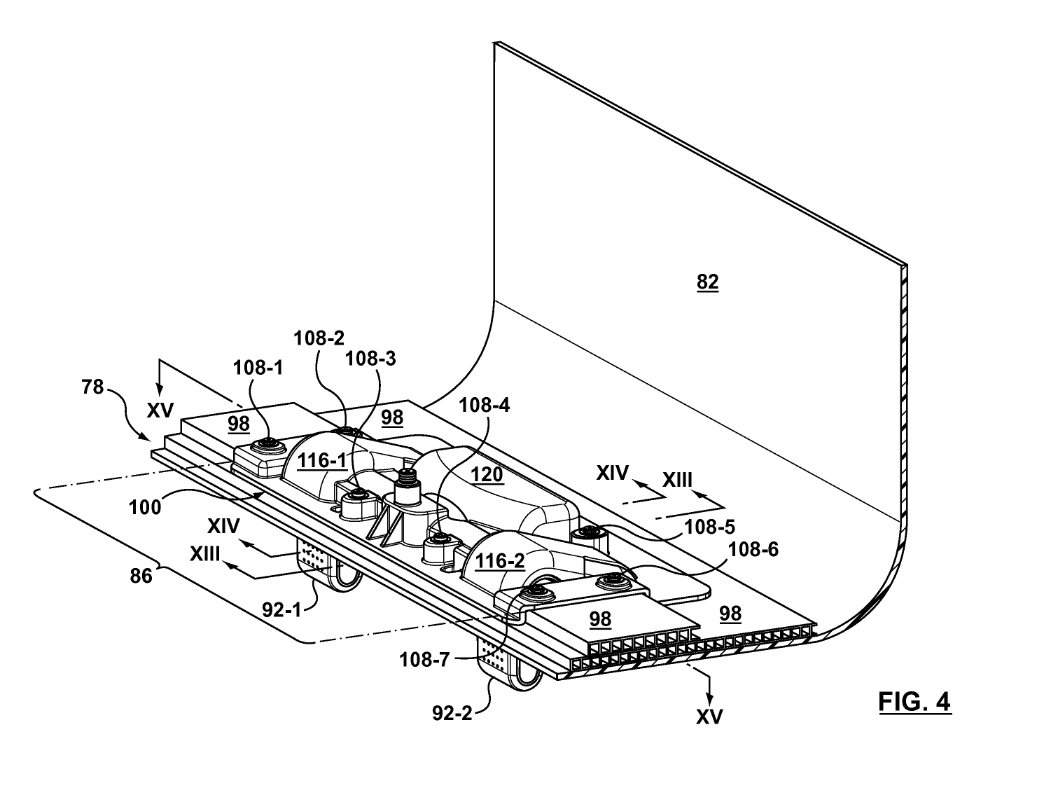

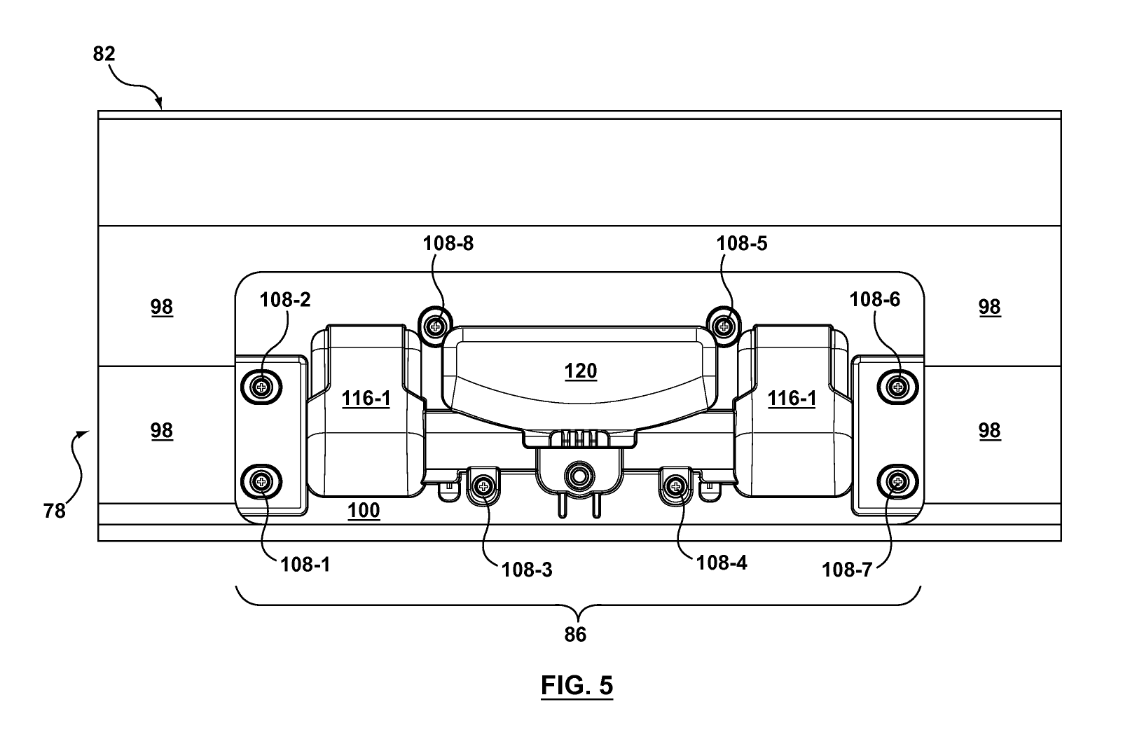

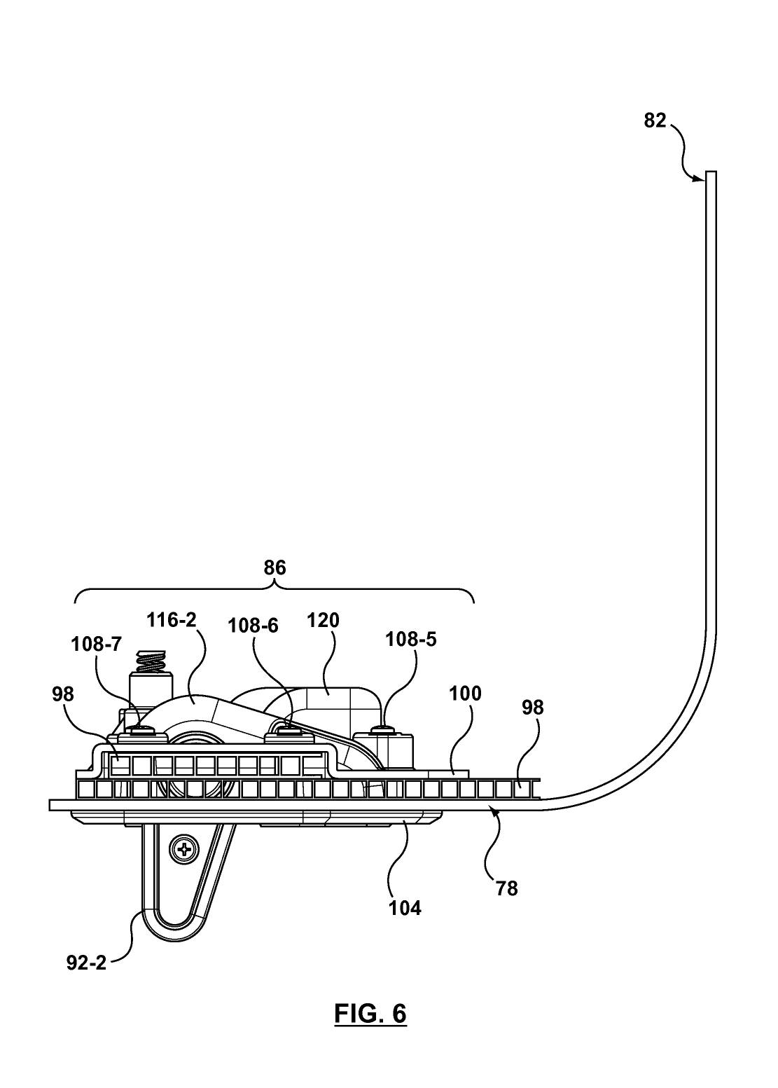

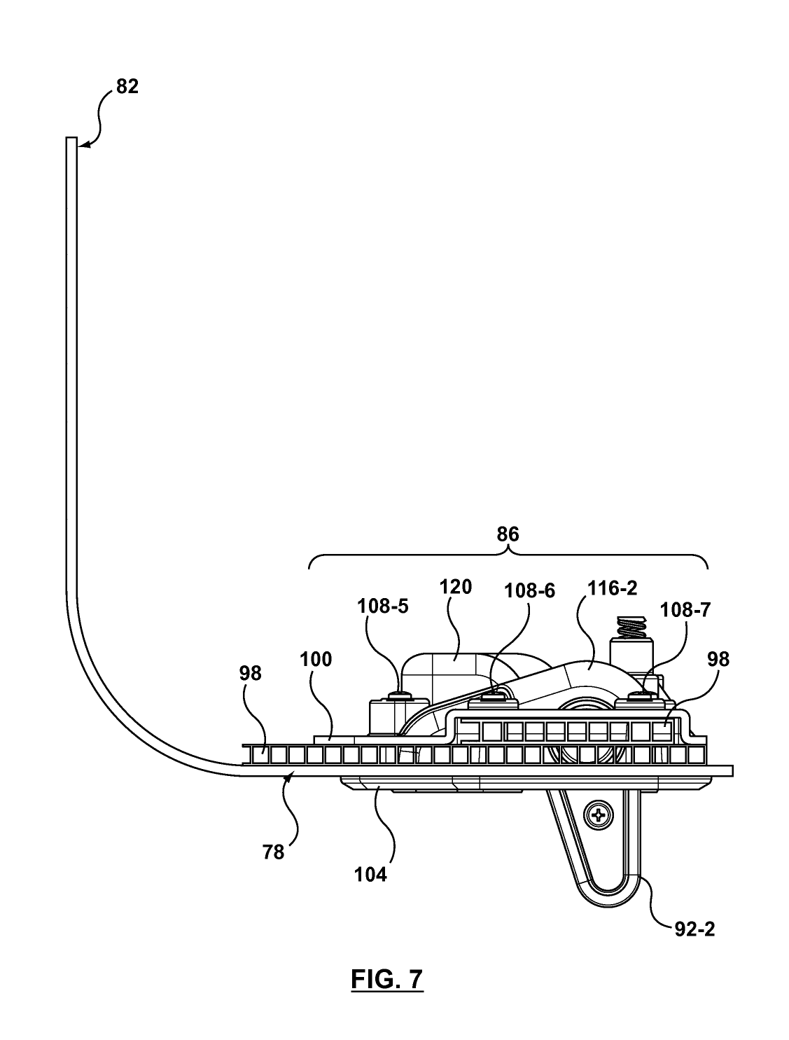

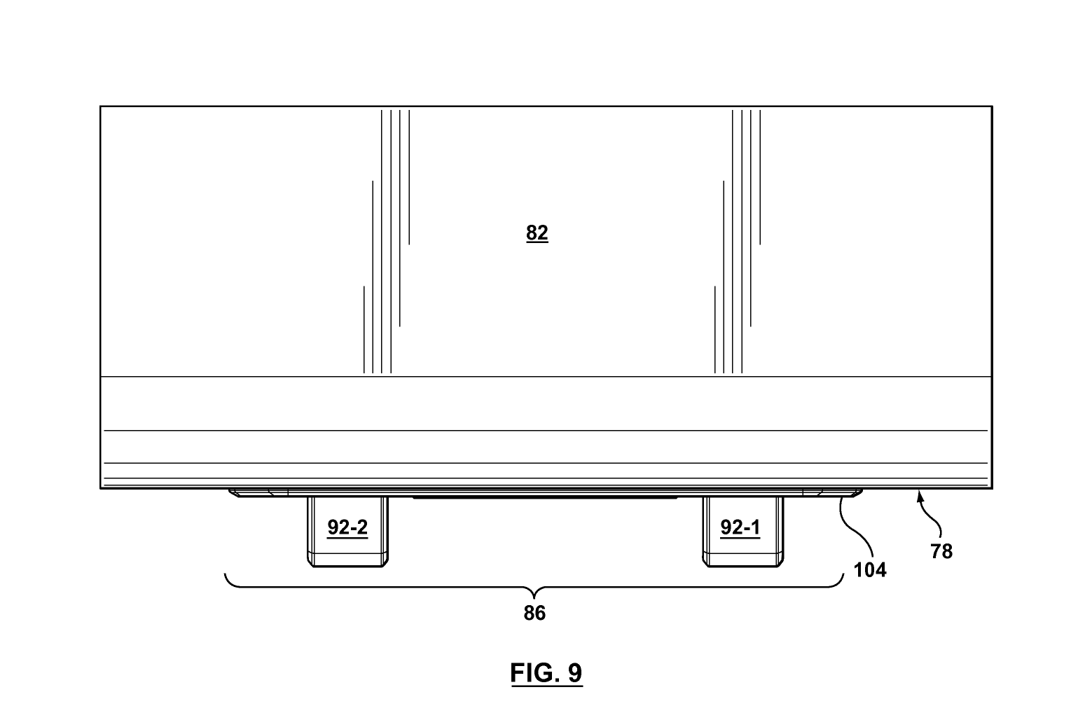

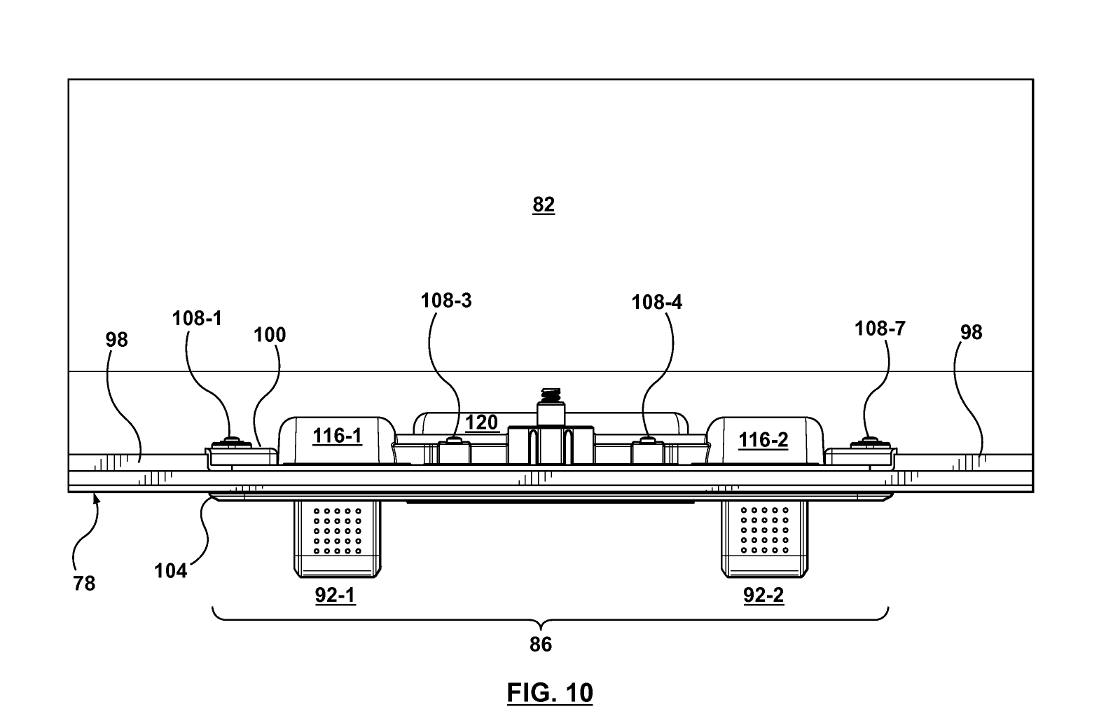

Referring now to FIGS. 4-13, stabilization mechanism 86 is shown in greater detail, in context with a section of base 78 and first wall 82 of compartment 54. FIGS. 4-14 also show a stepped planar reinforcing member 98 contiguous with base 78 that provides further rigidity to base 78. In a present embodiment reinforcing member 98 is made from corrugated plastic sheeting, where the stepped portion comprises two layers of such sheeting. Other ways of implementing reinforcing member 98 will now occur to those skilled in the art.

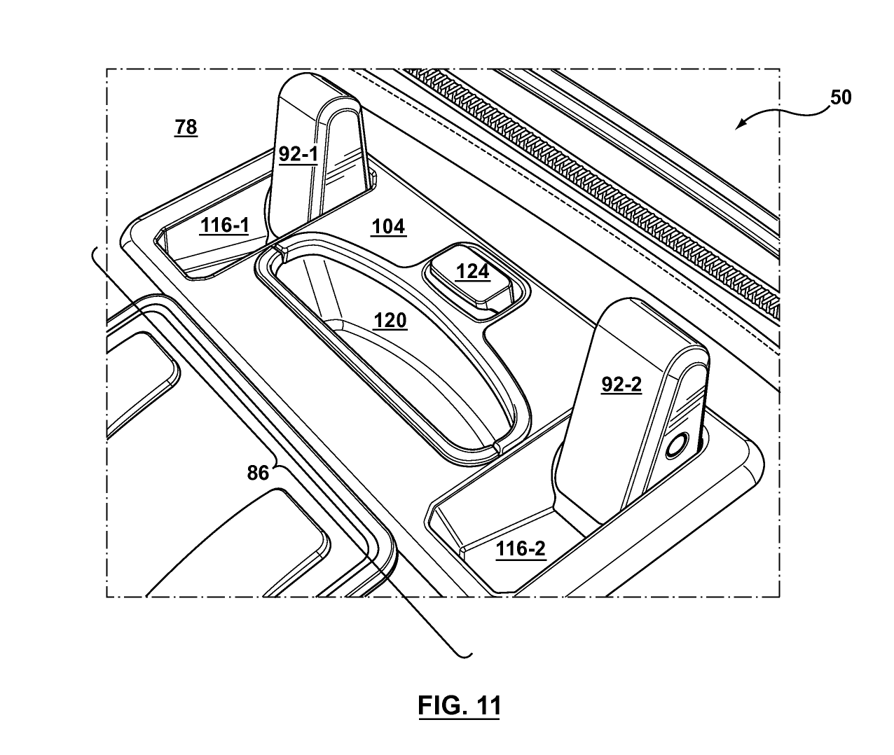

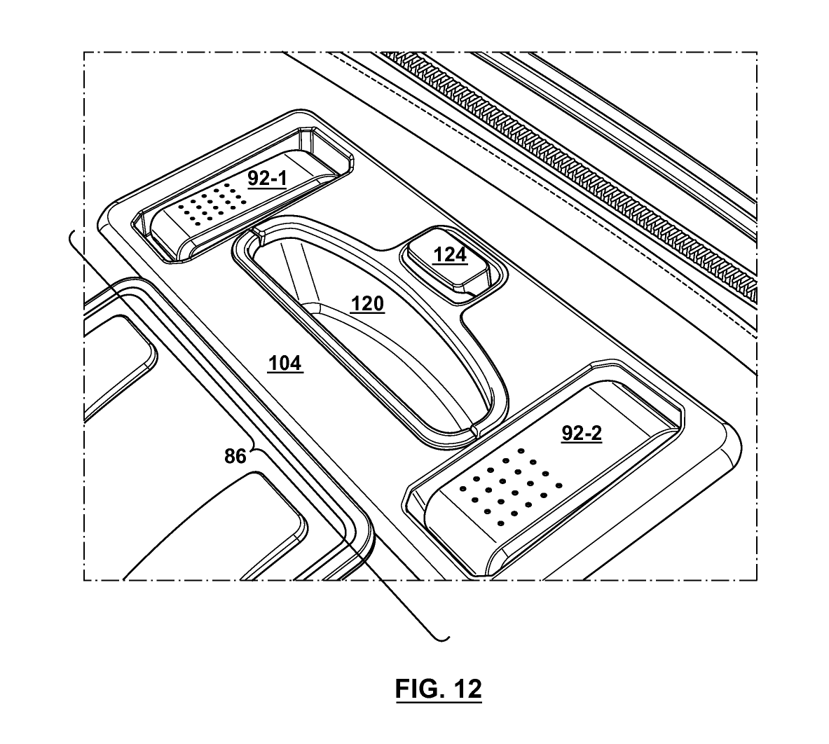

Stabilization mechanism 86 thus comprises a chassis 100 disposed within compartment 54 along the base 78. Chassis 100 can be molded from plastic or metal or other materials capable of formation. As best seen in FIG. 11 and FIG. 12, a substantially planar cover 104 is disposed on the exterior of base 78.

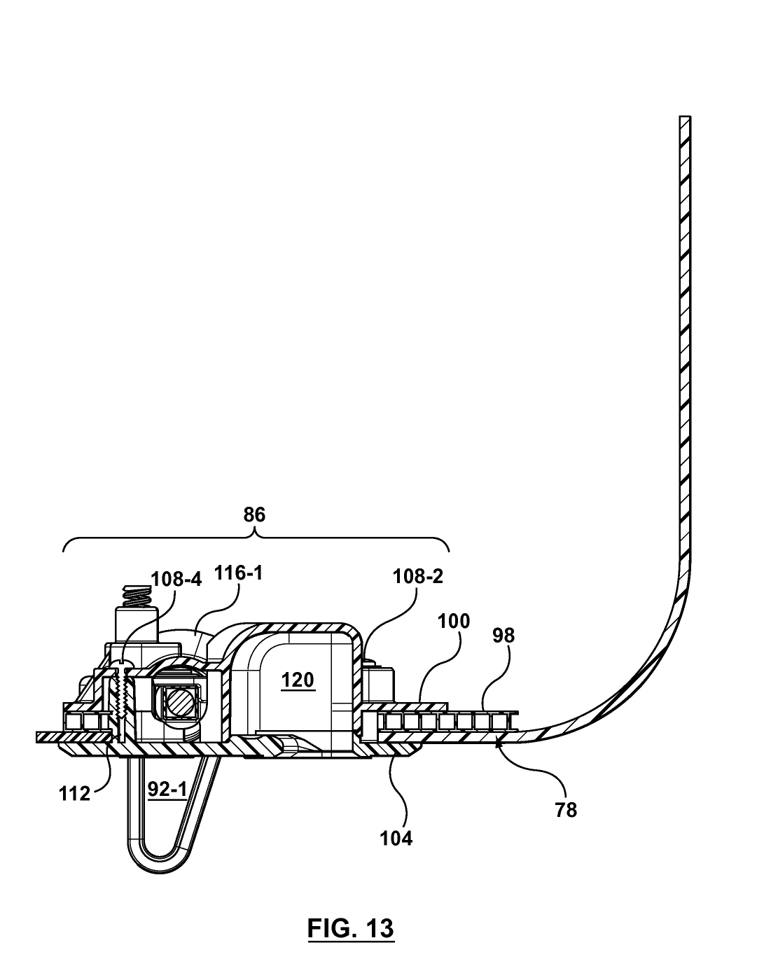

As best seen in FIG. 4 and FIG. 13, a plurality of fasteners 108, implemented as screws in this embodiment, pass through respective openings in chassis 100 and are received within corresponding threaded sockets 112 (only one of which is shown in FIG. 13) disposed along cover 104. Fasteners 108 thus secure chassis 100 to the interior of compartment 54 and to secure cover 104 to the exterior of compartment 54. The connection of cover 104 to chassis 100 sandwiches base 78 and stepped planar reinforcing member 98 therebetween. It will now be apparent that an opening is provided in base 78 to accommodate the junction of chassis 100 and cover 104.

Referring generally to FIG. 4-15, chassis 100 and cover 104 also formed to comprise a pair of recesses 116. As best seen in FIG. 11, each recess is complementary in shape to a respective foot 92. As best seen in FIG. 12, each recess 116 is configured to accommodate retraction of a respective foot 92 that corresponds with the stowage position of FIG. 3. Each foot 92 is hinged and therefore movable between the extended position in FIG. 11 and the retracted position in FIG. 12. Note that in the view of FIG. 12, when feet 92 are recessed then stabilization mechanism 86 becomes substantially flush with the exterior of base 78.

Referring again generally to FIGS. 4-15, chassis 100 and cover 104 are also formed to comprise a recessed handle 120. One or more fingers of one hand can be inserted within handle 120, while the other hand is used to hold another side (typically the opposite side, which may or may not include a handle) of luggage 50 to lift luggage 50. Many uses may be contemplated for handle 120, but as a non-limiting example, handle 120 can be used for placing luggage 50 into an overhead storage compartment on an aircraft or other vehicle. Recessed handle 120 can in fact be omitted altogether, or can be substituted with a strap or other type of grip.

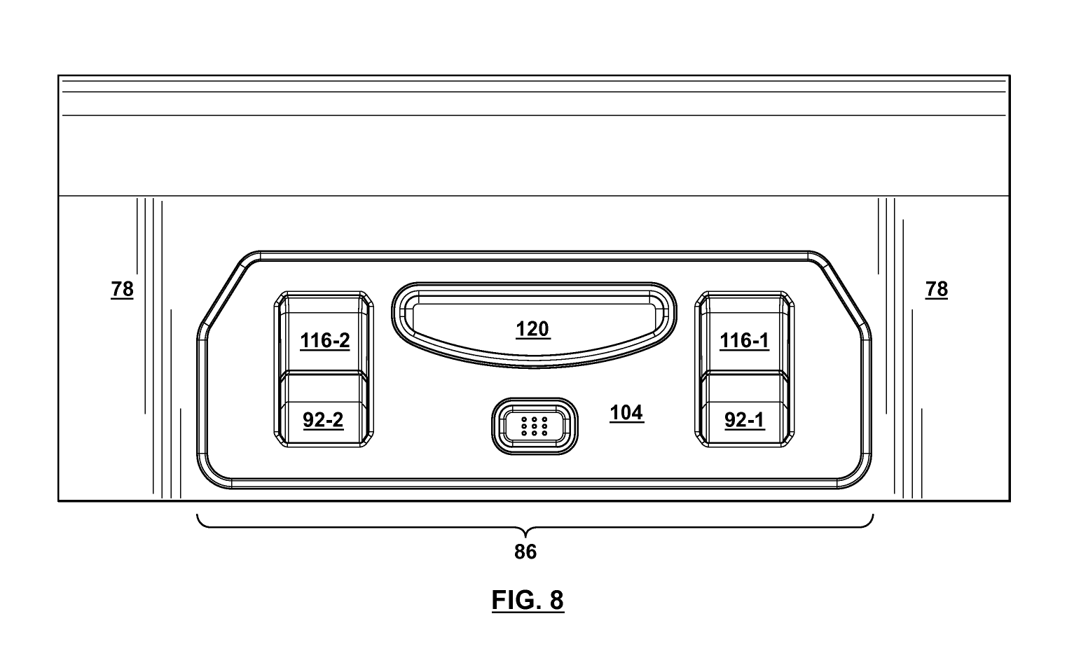

As seen in FIGS. 8, 11, 12 and 14, a release actuator in the form of a button 124 is provided on cover 104. Button 124 is configured to deploy feet 92 from the retracted position in FIG. 12 to the extended position in FIG. 11. Expressed in other words, when feet 92 are retracted as shown in FIG. 12, button 124 can be depressed so that feet 92 are deployed and move from their retracted position within recesses 116 to the extended position shown in FIG. 12. It will now be apparent that a retaining mechanism is provided to retain feet 92 in their retracted position, and that button 124 is connected to the retaining mechanism to release feet 92. It is contemplated that feet 92 are also connected to a biasing means that urges feet 92 towards the extended position, but the force of which may be overcome by the retaining mechanism as long as the retaining mechanism is not released by button 124.

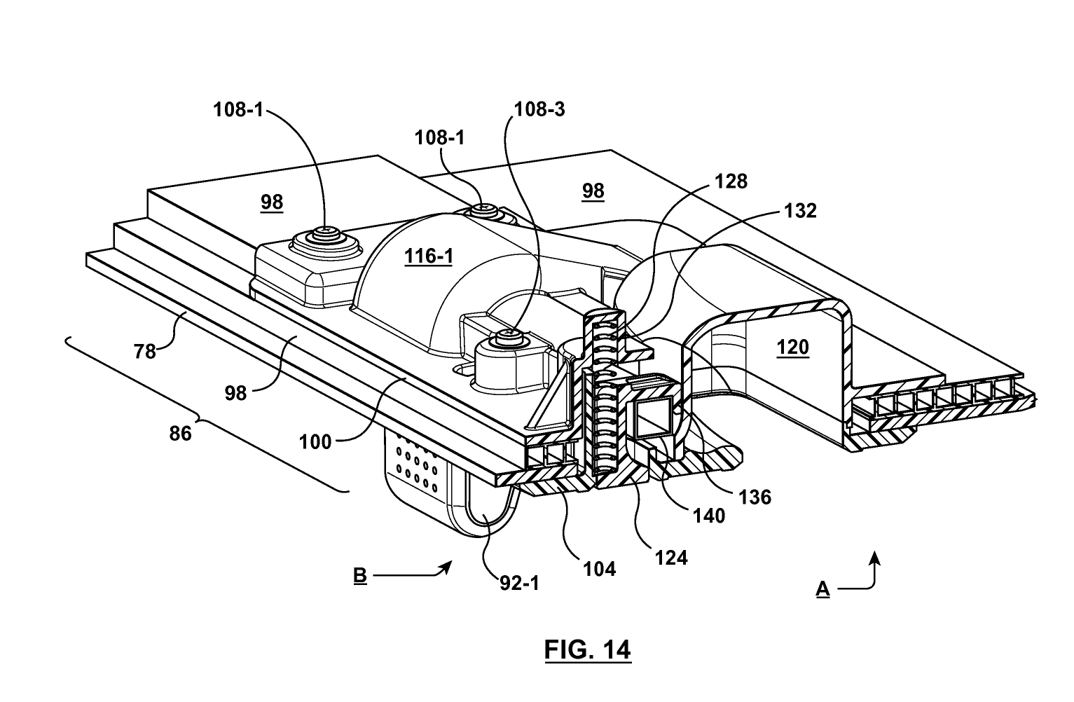

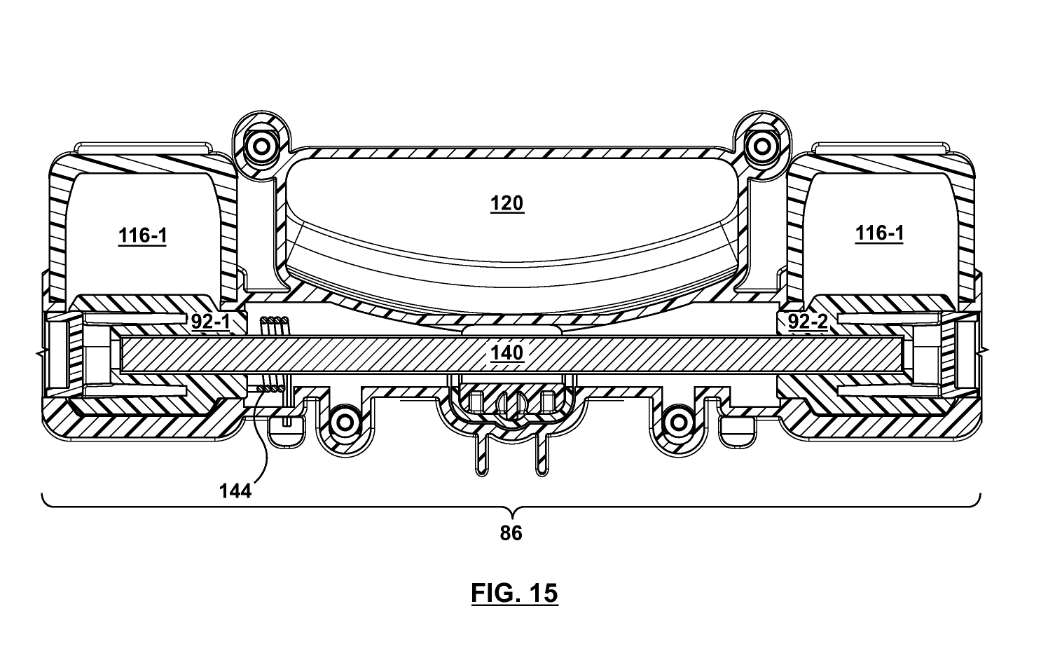

A specific way of implementing the retaining mechanism as described above is shown in FIG. 14 and FIG. 15. Referring first to FIG. 14, a first biasing means in the form of a helical spring 128 is shown retained within a cylindrical chamber 132 formed within chassis 100. Spring 128 is in mechanical communication with button 124 and thus urges button 124 towards cover 104 and away from chassis 10. When button 124 is in the position shown 14, a hooked-portion 136 of button 124 retains a squared-shaft 140 in a substantially fixed position. As best seen in FIG. 15, squared shaft 140 spans each foot 92, such that each foot 92 rotates in conjunction with the rotation of shaft 140.

Referring again to FIG. 14, when button 124 is depressed, thereby compressing spring 128 and moving hooked-portion 136 out of engagement with shaft 140, shaft 140 becomes rotatable along its axis. A ninety-degree rotation of shaft 140 in the direction of arrow “A” as shown in FIG. 14 corresponds with movement of feet 92 from the extended position to the retracted position. An application of force (e.g. with a finger) to a foot 92 along the direction of arrow “B”, along with appropriate depression of button 124, results in movement of feet 92 into the retracted position from the extended position shown in FIG. 14. At the conclusion of such a ninety-degree rotation, hooked portion 136 re-engages with shaft 140 to thereby secure shaft 140 from further rotation and thereby retain feet 92 in the retracted position.

Referring again to FIG. 15, a second biasing means in the form of a spring 144 that is coiled around shaft 140 is disposed to bias rotation of shaft 140 and feet 92 towards the extended position. Thus, depression of button 124 while feet 92 are in the retracted position will result in spring 144 urging feet 92 into the extended position.

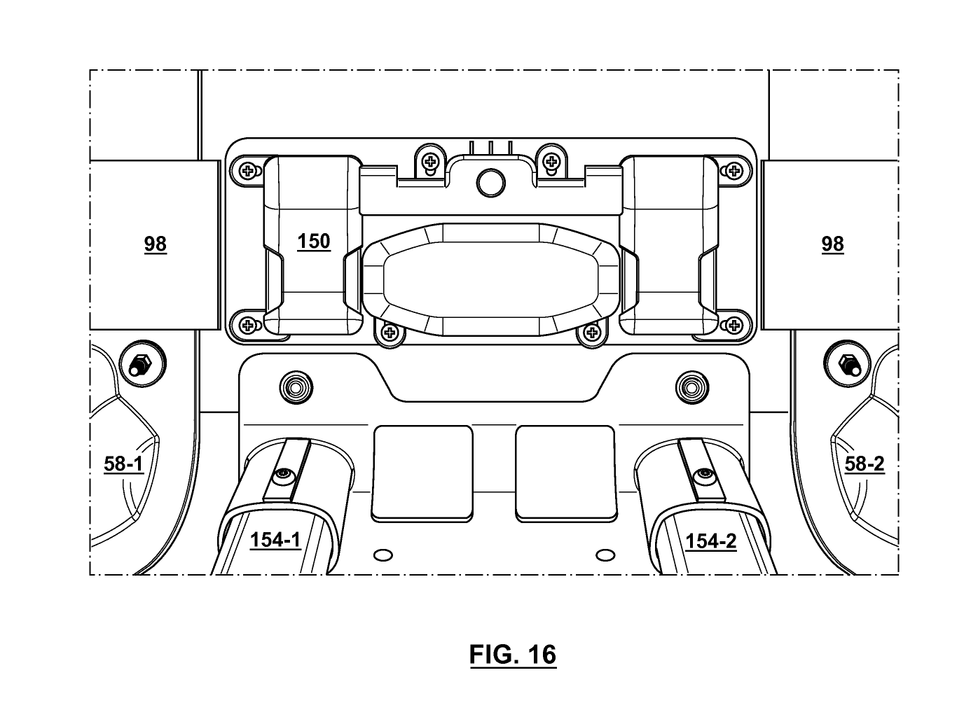

Referring now to FIG. 16, a protective cover 150 can optionally be applied over chassis 100 to provide further mechanical strength and protect the introduction of contaminants (e.g. dust) from entering the mechanisms within chassis 100. Also optionally, one or more reinforcing struts 154 can be installed in compartment 54 in order to provide further rigidity and strength to luggage 50.

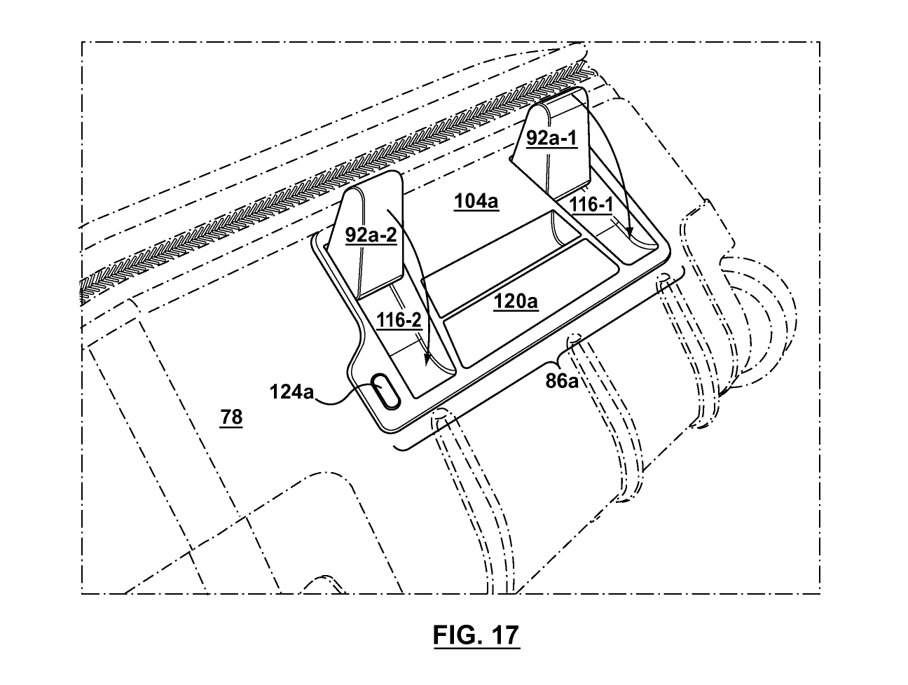

Variations are contemplated. For example, FIG. 17 shows another stabilization mechanism 86a that is a variation on stabilization mechanism 86. Accordingly, in stabilization mechanism 86a, like elements bear like references to their counterparts in stabilization mechanism 86, except followed by the suffix “a”. Of note is that handle 120a has an angled entrance to improve grip. Also of note is that button 124a, for deploying feet 92a-1 and 92a-2, is located to the side of cover 104a, rather than in the center of cover 104a.

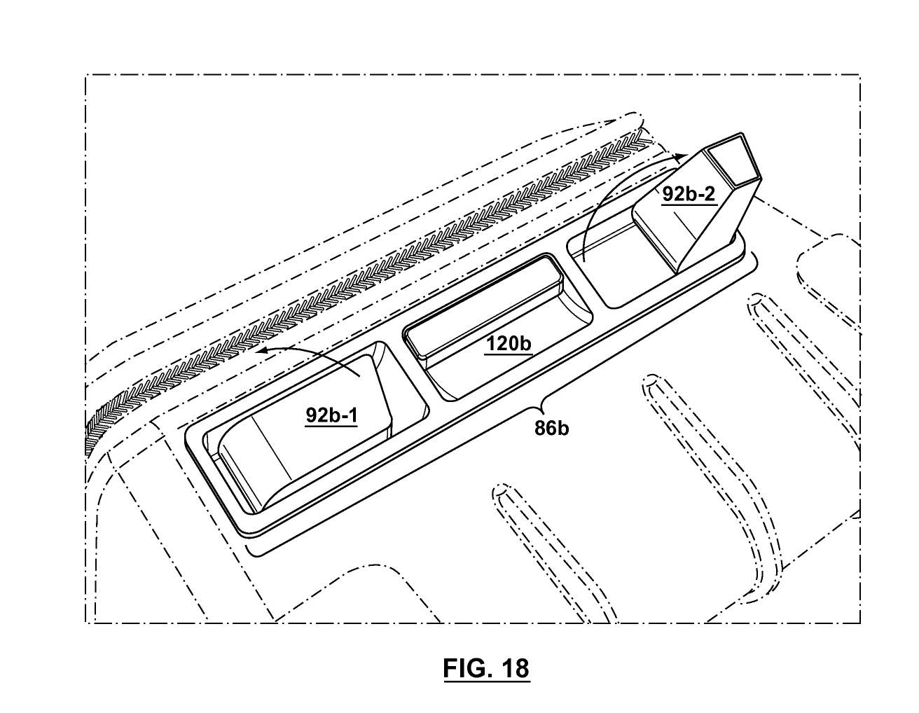

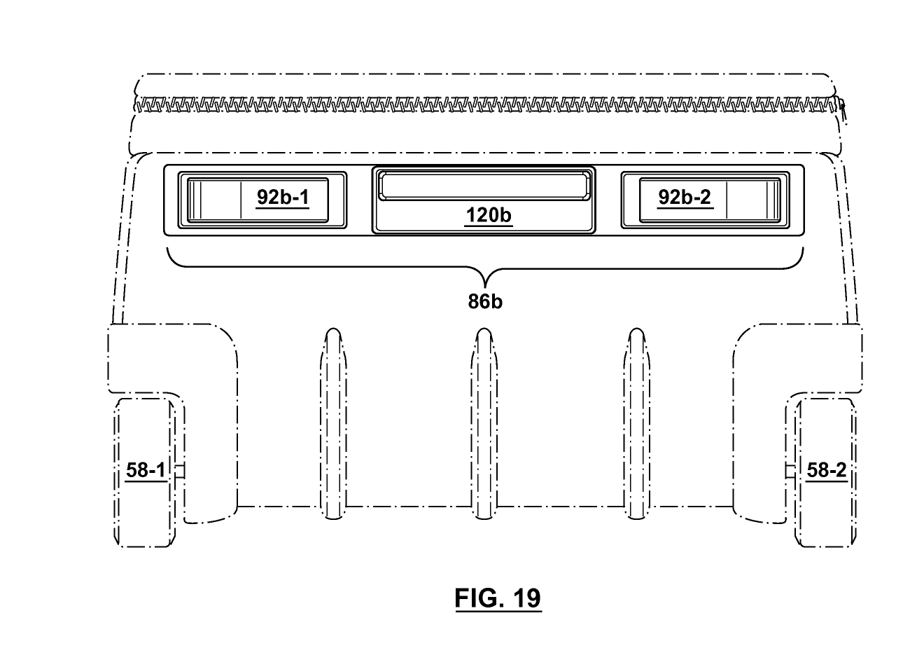

Another stabilization mechanism 86b is shown in FIG. 18 and FIG. 19. Stabilization mechanism 86b is also a further variation on stabilization mechanism 86. Of note is that in stabilization mechanism 86b, button 124 and the accompanying mechanisms are omitted altogether and each foot 92b is independently movable and they move in a direction that is perpendicular to the direction in relation to the movement of feet 92 of mechanism 86. As shown in FIG. 18, foot 92b-1 is in the retracted position, while foot 92b-2 is in the extended position. The embodiment in FIG. 18 highlights the point that button 124 and an integral release mechanism are not required. The embodiment in FIG. 18 also emphasizes that feet 92b can be deployed in different directions.

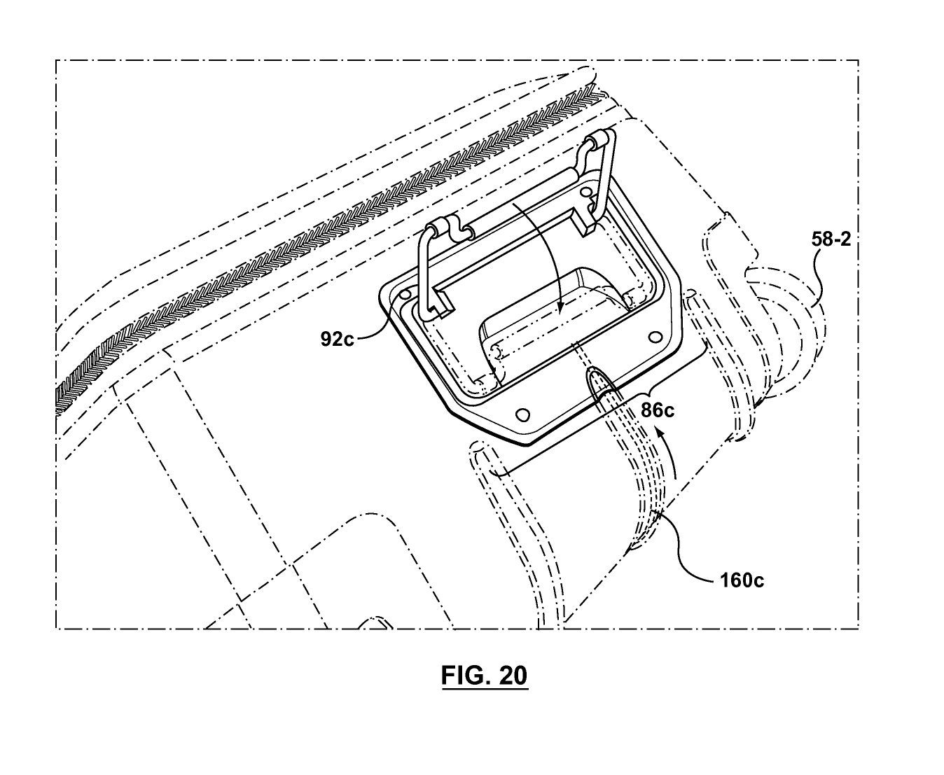

Another stabilization mechanism 86c is shown in FIG. 20. Stabilization mechanism 86c is also a further variation on stabilization mechanism 86. Of note is that in stabilization mechanism 86c, only a single foot 92c is provided. Foot 92c is configured from a wire bale. The wire bale is bent into a “M” shape with the trough of the M serving as a handle that is kept relatively clean by avoiding contact with the rolling surface when deployed. The peaks of the “M” serve as separate feet-rests. Button 124 is omitted and instead a pull-cable 160c is provided as a release actuator for deploying foot 92c. The pull-cable 160c can be housed in a plastic sleeve along the exterior of compartment 54 to a handle (not shown) disposed at the top of compartment 54.

Further variations, combinations, and subsets of the foregoing will now occur to those skilled in the art.

1. A stabilization mechanism for an article of luggage comprising:
at least one foot movable between an extended position for stabilizing said luggage and a retracted position; such that when said foot is extended said compartment is less prone to tipping than when said foot is in said retracted position; and
a chassis disposed within a compartment of said luggage; said chassis having at least one recess for receiving said at least one foot in said retracted position, such that when said foot is retracted a volume of said article is substantially identical to a volume of said compartment.

2. The stabilization mechanism of claim 1 further comprising a handle recessed within said mechanism.

3. The stabilization mechanism of claim 1 further comprising a retaining mechanism for maintaining said at least one foot in at least one of said extended position and said retracted position.

4. The stabilization mechanism of claim 3 further comprising a biasing means within said chassis for urging said at least one foot into said extended position.

5. The stabilization mechanism of claim 4 further comprising a release actuator for disengaging said retaining mechanism and so that said biasing means acts on said at least one foot to urge said at least foot from said retracted position to said extended position.

6. The stabilization mechanism of claim 5 wherein said release actuator is a button disposed on said chassis.

7. The stabilization mechanism of claim 6 wherein said button is disposed centrally on said chassis.

8. The stabilization mechanism of claim 7 wherein said at least one foot comprises two feet disposed on either side of said button.

9. The stabilization mechanism of claim 8 further comprising a substantially planar cover mounted on an exterior of said luggage and affixed to said chassis.

10. An article of luggage comprising:
an object for transport;
at least one wheel connected a first side of said object; said at least one wheel for rolling said object along a rolling surface; and
a stabilization mechanism attached to said second side; said stabilization mechanism having at least one foot movable between an extended position for stabilizing said luggage and a retracted position; such that when said foot is extended said object is less prone to tipping than when said foot is in said retracted position; a chassis disposed within said object; said chassis having at least one recess for receiving said at least one foot in said retracted position, such that when said foot is retracted a volume of said article is substantially identical to a volume of said compartment.

11. The article of luggage of claim 10 wherein said object is substantially cuboid.

12. The article of luggage of claim 10 wherein said object is a compartment.

13. The article of luggage of claim 12 wherein said compartment is substantially cuboid.

14. The article of luggage of claim 13 further comprising a handle connected to a second side of said object via a retractable rod; said second side opposite to said first side.

15. The article of luggage of claim 13 wherein said handle is retractable within a chamber disposed on said second side.

16. The article of luggage of claim 15 having a stowage position wherein said handle is retracted and said foot is in said retracted position.

17. The article of luggage of claim 16 wherein when said luggage in said stowage position said article of luggage occupies a cuboid volume substantially equivalent to a volume of said compartment.
